(19) United States
(12) Patent Application Publication
(10) Pub. No.: US 2026/0088841 A1
(43) Pub. Date: Mar. 26, 2026

(54) PARALLEL RADIOFREQUENCY BLANKING SWITCH SYSTEM, APPARATUS AND METHOD

(71) Applicant: The United States of America as represented by the Secretary of the Navy, Arlington, VA (US)

(72) Inventor: Frederick Joseph Verd, Cache, OK (US)

(73) Assignee: The United States of America as represented by the Secretary of the Navy, Arlington, VA (US)

(21) Appl. No.: 18/896,099

(22) Filed: Sep. 25, 2024

(51) Int. Cl. H04B 1/04; H01Q 21/00

(52) U.S. Cl. CPC H04B 1/0475; H01Q 21/00

(57) ABSTRACT

A parallel radiofrequency blanking switch system, apparatus and method. In some embodiments, a parallel radiofrequency blanking switch apparatus, comprising a plurality of capacitors electrically connected in parallel to a transmission line, and configured to not affect the natural electro-magnetic response of the transmission line; an inductor electrically connected in series with at least one of the plurality of capacitors, a diode electrically connected to the plurality of capacitors, and wherein the diode is tuned to selectively targets a specific frequency band for attenuation or blanking; and a single direct current power source configured to supply a control signal, wherein the single direct current power source may activate the diode for selective attenuation or blanking.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: NIWC_Pacific_T2@us.navy.mil, referencing Navy Case No. 210,993.

### BACKGROUND

Transmission lines commonly use active components to blank or attenuate a carried signal. However, a transmission line's electromagnetic mode and impedance lines are impacted by active components, impacting both the signal's amplitude and phase. This occurs when active components are added in series. Physical contact with the transmission line and affects the signal, regardless of whether the device is on or off. This direct contact can cause active components to change their capacitive responses and cause a radiofrequency (RF) spike on the transmission line. Furthermore, active components require three direct current (DC) voltages: positive, negative, and ground.

Some systems are especially sensitive to RF spikes on the transmission. For one example, RF spikes can cause problems in sensitive phased array antenna systems. Minimizing or eliminating RF spikes is important for sensitive systems. Additionally, RF blanking and attenuation technology face a continual need for small, simpler systems. Not only do smaller and simplified system allow for special efficiency, but also improve reliability and ease of repair. Accordingly, there is a continuous desire to make such components smaller, simpler, and more efficient.

### SUMMARY

According to illustrative embodiments, a parallel radiofrequency blanking switch apparatus, comprising a plurality of capacitors electrically connected in parallel to a transmission line, and configured to not affect the natural electro-magnetic response of the transmission line; an inductor electrically connected in series with at least one of the plurality of capacitors, a diode electrically connected to the plurality of capacitors, and wherein the diode is tuned to selectively targets a specific frequency band for attenuation or blanking; and a single direct current power source configured to supply a control signal, wherein the single direct current power source may activate the diode for selective attenuation or blanking.

In some embodiments, a parallel radiofrequency blanking switch system, comprising: a transmission line having at least two ports; and a plurality parallel radiofrequency blanking switch apparatuses configured to attenuate a plurality of frequencies bands, each further comprising: a plurality of capacitors electrically connected in parallel to the at least two ports, and configured to not affect the natural electro-magnetic response of the transmission line an inductor electrically connected in series with at least one of the plurality of capacitors, a diode electrically connected to the plurality of capacitors, and wherein the diode is tuned to selectively targets a specific frequency band for attenuation or blanking, and a single direct current power source configured to supply a control signal, wherein the single direct current power source may activate the diode for selective attenuation or blanking.

In some embodiments, a method for blanking a signal with a parallel radiofrequency blanking switch system, the steps comprising: providing a parallel radiofrequency blanking switch system, comprising: a transmission line having at least two ports, and a plurality parallel radiofrequency blanking switch apparatuses configured to attenuate a plurality of frequencies bands, each further comprising: a plurality of capacitors electrically connected in parallel to the at least two ports, and configured to not affect the natural electro-magnetic response of the transmission line an inductor electrically connected in series with at least one of the plurality of capacitors, a diode electrically connected to the plurality of capacitors, and a single direct current power source configured to supply a control signal, wherein the single direct current power source may activate the diode for selective attenuation or blanking; transmitting a transmission signal through the transmission line; activating each diode of the plurality of radiofrequency blanking switch apparatuses; and selectively filtering the transmission signal, and wherein each diode of the plurality of parallel radiofrequency blanking switch apparatuses is tuned to selectively targets a specific frequency band for attenuation or blanking.

It is an object to provide a radiofrequency blanking switch system and apparatus utilizing parallel connections that offers numerous benefits, including working as a frequency selective filter to blank or cancel a targeted frequency band. In doing so, an amplitude modulated signal is produced in the targeted band without affecting the DC current and frequencies outside of the targeted band.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 is an illustration of a transmission line and ports for a Parallel Radiofrequency Blanking Switch System and Apparatus.

FIG. 2 shows a three-dimensional illustration of a transmission line and ports a Parallel Radiofrequency Blanking Switch System and Apparatus.

FIG. 3 shows an exemplary illustration of a circuit diagram illustration for a Parallel Radiofrequency Blanking Switch System and Apparatus.

FIG. 4 shows exemplary signal blanking results for a Parallel Radiofrequency Blanking Switch System and Apparatus.

FIG. 5 shows exemplary block diagram illustration of a Method for Blanking a Signal with a Parallel Radiofrequency Blanking Switch System.

### DETAILED DESCRIPTION OF EMBODIMENTS

The disclosed apparatus, system, and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other apparatus, system, and method described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

Creating an amplitude modulated signal by blanking a specific band of a frequency is challenging in applications including, but not limited to, phased antenna arrays. Blanking or attenuating a frequency band in a transmission is commonly performed by active components. However, placing active components in series with the transmission line can cause an unavoidable radiofrequency spike. This spike is unavoidable because it changes the natural transmission line's electro-magnetic mode. Even when the active components are turned off, the signal still experiences disruption because it must always pass through the active device, regardless of whether it is on or off.

The subject matter of the disclosure here presents a Parallel Radiofrequency Blanking Switch System and Apparatus capable of creating an amplitude modulated signal by blanking or attenuating frequency bands while isolating the transmission line from disruptions. To accomplish this, the Parallel Radiofrequency Blanking Switch System and Apparatus connects to the transmission line in parallel, keeping the voltage source isolated. This unique construction keeps the transmission line path intact to better support phase and amplitude control. To achieve amplitude modulation, frequencies are targeting for blanking or by tuning a control signal. In some embodiments, the control signal may be sourced from DC voltage and supply a differential signal or a digital signal. Ultimately, the system, method, and apparatus provides significant benefit for applications requiring sensitive amplitude modulation.

An additional benefit of the disclose subject matter is that a Parallel RF Blanking Switch System and Apparatus only requires one DC voltage. It is common for amplitude modulation systems to utilize three current sources for blanking and attenuation. These three voltages are used to switch between positive, negative and ground. Herein, a single DC voltage source may be used as a differential or digital control signal. The differential signal may be positive, negative, or provide no power. Consequently, this design also allows 3 modes of operation—on, off, and no power. Requiring only one direct current voltage is advantageous over systems requiring three DC voltages for reasons including design simplicity and efficiency.

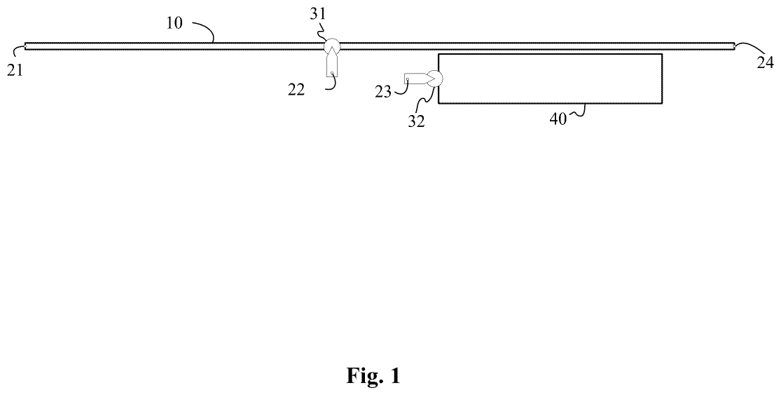

FIG. 1 is an illustration of a transmission line and ports for connecting to a Parallel Radiofrequency Blanking Switch System comprising a transmission line 10, four ports (in this embodiment) 21-24, two vias (in this embodiment) 31-32, and an open stub 40. The Parallel Radiofrequency Blanking Switch System and Apparatus may be electrically connected to the second port 22 and third port 23. The second port 22 may be connected to the transmission line 10 and enable a radiofrequency signal to travel along the transmission line. The third port 23 may be electrically connected to open stub 40. Transmission lines 10 may comprise a plurality of ports and are configured to carry a transmission signal that may be amplitude modulated.

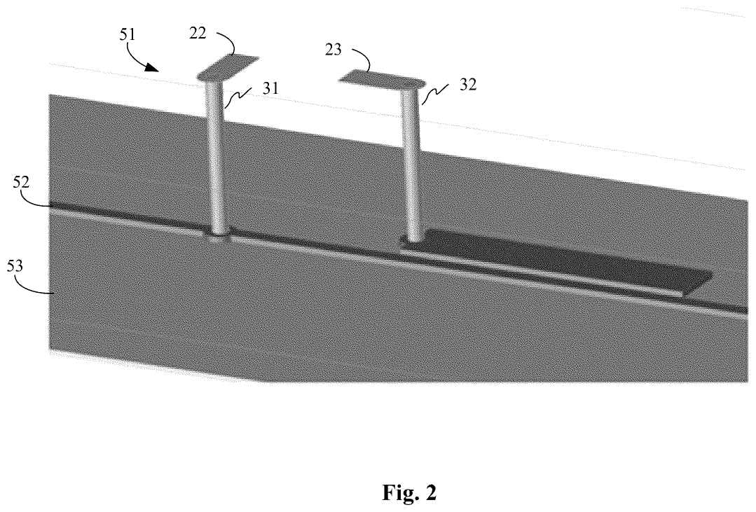

FIG. 2 shows a three-dimensional illustration of some embodiments of the structure of a Parallel Radiofrequency Blanking Switch System and Apparatus comprising a top layer for circuit components 51, a middle layer for RF connectivity 52, and a bottom layer or ground plane 53. The top layer 100 may further comprise components of Parallel Radiofrequency Blanking Switch Apparatus connected to the plurality of ports 23 and 23. In some embodiments, the middle layer 52 may further comprise the transmission line 10 and open stub 40. The bottom layer 53 may serve as a ground plane or bottom layer 53 for the middle layer 52 to be stacked on. As shown in FIG. 2, the Parallel Radiofrequency Blanking Switch System and Apparatus may be connected to the transmission line in parallel so as to not impact the transmission line's 10 electromagnetic response.

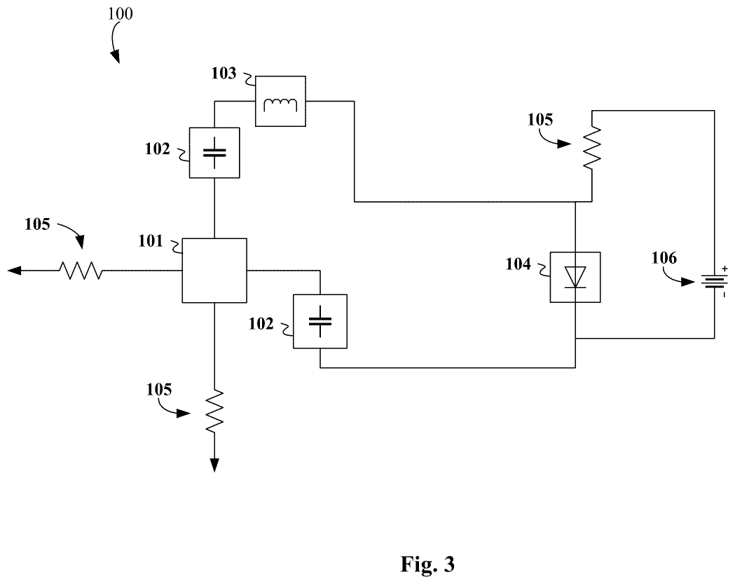

FIG. 3 shows an exemplary illustration of a circuit diagram illustration for a Parallel Radiofrequency Blanking Switch Apparatus comprising a plurality of capacitors 102, an inductor 103, a diode 103, and direct current power source 106. The Parallel Radiofrequency Blanking Switch Apparatus 100 may also include a port structure 101 to facilitate a connection to the transmission line or be optionally used for simulation/testing purposes. Additionally, the Parallel Radiofrequency Blanking Switch Apparatus 100 may comprise a plurality of resistors 105. The plurality of capacitors may be electrically connected in parallel to the at least two ports 22-23. The inductor 103 may be electrically connected in series with at least one of the plurality of capacitors. The diode 104 may be electrically connected to the plurality of capacitors. The direct current power source 106 is a single DC power source and may be configured to supply a control signal that is either a differential or digital signal.

The plurality of capacitors 102 may be electrically connected in parallel to a transmission line and are directly connected to the port. Furthermore, the plurality of capacitors 102 electrically isolate the transmission line from a natural electro-magnetic response of the circuit. The connection to the transmission line may be facilitated through the port structure 101 or by ports 22-23 directly connected to the transmission line. The Parallel Radiofrequency Blanking Switch Apparatus is configured to be a parallel circuit able to not affect the natural electro-magnetic response of the transmission line. Accordingly, the plurality of capacitors 102 may isolate the transmission line from electromagnetic effects of the circuit while in the “Off” or “No power” states.

The inductor 103 may be electrically connected in series with at least one of the plurality of capacitors. Additionally, the inductor 103 may be electrically connected to the diode 104 or a resistor 105. The inductor 103 may be configured to tune the circuit to a specific frequency, filter out certain frequencies, or to smooth out current fluctuations in the circuit.

The diode 104 is a semiconductor devices that allow for current flow in one direction while blocking it in another direction. Furthermore, the diode 104 is tuned to selectively target a specific frequency band for attenuation or blanking. In a parallel radiofrequency blanking switch system there may be a plurality of diodes 104 each tuned to blank or attenuate a specific frequency along the transmission line 10. The blanking or attenuation enabled by each of the tuned diodes may be controlled in concert, with an external controller of CPU device. The combination of a plurality of diodes 104 tuned to unique, specific frequencies allow for the amplitude modulation of a plurality of frequencies and, therefore, may modulate the signal.

The direct power source 106 may be configured to configure to supply a control signal. In some embodiments, the control signal may be a DC voltage, a differential signal, or a digital signal. Furthermore, the direct current power source 106 may activate the diode 104 for selective attenuation or blanking. In some embodiments, it may function as an “On”/“Off”/“No power” switch. When switched “On” the power source 106 may supply power to at least one diode 103 tuned to a frequency to be attenuated. When the power is switched off, the parallel circuit has no effect. Similarly, when the power source is not supplied, the parallel circuit may also have no effect. The field of the switch does not touch the transmission line. In some embodiments, the direct power source 106 may be DC power supply which may include batteries, DC power supplies, DC generators, thermoelectric generators, piezoelectric devices, and capacitors in certain configurations.

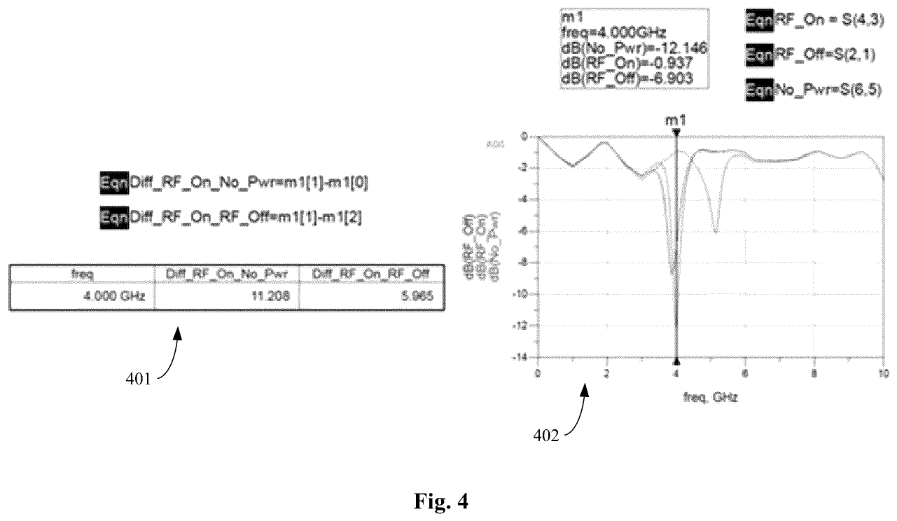

FIG. 4 shows exemplary signal blanking results for a Parallel Radiofrequency Blanking Switch Apparatus comprising a graph 402 of frequency (measured in gigahertz) versus decibels of the circuit in the 3 power states (“On”, “Off”, and “No Power”), and a chart 401 of the differential, at 4 GHz of “On” and “No Power” and “On and Off”. In this embodiment, the diode 104 of the Parallel Radiofrequency Blanking Switch Apparatus used here is tuned to an attenuation frequency of 4 GHz. As shown on the graph 402, at 4 GHz the dB measurement of “Off” is −6.903, “On” is −0.937, and “No Power” is −12.146. The differential power for these states are 11.208 between “No Power” to “On”, and 5.965 between “On” and “Off”. In graph 402 the lines are differentiated based on their shade. Furthermore, the “Off” state is seen to be at the lowest dip around −8.25 dB 4 GHz, the “No Power” state is seen to dip around −12 around 4 GHz, and “On” dips to −6 around 5 G Hz. When power source 106 is turned “On”, the diode 104 is invoked and permits current flow in one direction associated with a turned current flow that attenuates or blanks a specific frequency.

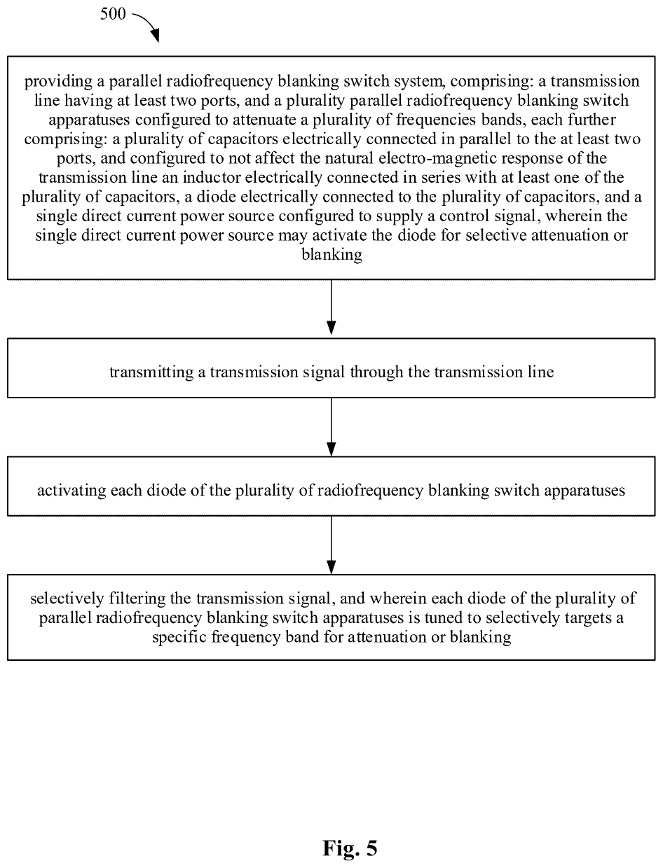

FIG. 5 shows exemplary block diagram illustration of a Method for Blanking a Signal with a Parallel Radiofrequency Blanking Switch System comprising: providing a parallel radiofrequency blanking switch system, comprising: a transmission line having at least two ports; a radiofrequency blanking circuit configured to not affect the natural electro-magnetic response of the transmission line, and further comprising: a plurality of capacitors electrically connected in parallel to the at least two ports, an inductor electrically connected in series with at least one of the plurality of capacitors, a diode electrically connected to the plurality of capacitors, and a single direct current power source configured to supply a control signal, wherein the single direct current power source may comprise states of on, off, or no power; transmitting a transmission signal through the transmission line; generating a plurality of capacitances in each of the plurality of capacitors; and selectively filtering the transmission signal, wherein the capacitance of each of the plurality of capacitors selectively targets a specific frequency band for attenuation or blanking.

The method 500 may further comprise, wherein the plurality of capacitors is a quantity of two.

The method 500 may further comprise, wherein the transmission line is electrically connected to support phased array antenna systems.

The method 500 may further comprise, wherein the control signal is a differential signal.

The method 500 may further comprise, wherein the control signal is a digital signal.

From the above description of a Parallel Radiofrequency Blanking Switch System, Apparatus and Method, it is manifest that various techniques may be used for implementing the concepts of a parallel radiofrequency blanking switch system, parallel radiofrequency blanking switch apparatus, and a method for blanking a signal with a parallel radiofrequency blanking switch system without departing from the scope of the claims. The described embodiments are to be considered in all respects as illustrative and not restrictive. The method, system, and apparatus disclosed herein may be practiced in the absence of any element that is not specifically claimed and/or disclosed herein. It should also be understood that a parallel radiofrequency blanking switch system, parallel radiofrequency blanking switch apparatus, and a method for blanking a signal with a parallel radiofrequency blanking switch system are not limited to the particular embodiments described herein, but is capable of many embodiments without departing from the scope of the claims.

What is claimed:

1. A parallel radiofrequency blanking switch apparatus, comprising:
a plurality of capacitors electrically connected in parallel to a transmission line and to a circuit, wherein the plurality of capacitors electrically isolate the transmission line from a natural electro-magnetic response of the circuit;
an inductor electrically connected in series with at least one of the plurality of capacitors, a diode electrically connected to the plurality of capacitors, and wherein the diode is tuned to selectively targets a specific frequency band for attenuation or blanking; and
a single direct current power source configured to supply a control signal, wherein the single direct current power source may activate the diode for selective attenuation or blanking.

2. The parallel radiofrequency blanking switch apparatus of claim 1, wherein the plurality of capacitors is a quantity of two.

3. The parallel radiofrequency blanking switch apparatus of claim 1, wherein the transmission line is electrically connected to support phased array antenna systems.

4. The parallel radiofrequency blanking switch apparatus of claim 1 wherein the control signal is a differential signal.

5. The parallel radiofrequency blanking switch apparatus of claim 1, wherein the control signal is a digital signal.

6. A parallel radiofrequency blanking switch system, comprising:
a transmission line having at least two ports; and
a plurality parallel radiofrequency blanking switch apparatuses configured to attenuate a plurality of frequencies bands, each further comprising:
a plurality of capacitors electrically connected in parallel to the at least two ports, wherein the plurality of capacitors electrically isolate the transmission line from a natural electro-magnetic response of each of the plurality parallel radiofrequency blanking switch apparatuses,
an inductor electrically connected in series with at least one of the plurality of capacitors,
a diode electrically connected to the plurality of capacitors, and wherein the diode is tuned to selectively targets a specific frequency band for attenuation or blanking, and
a single direct current power source configured to supply a control signal, wherein the single direct current power source may activate the diode for selective attenuation or blanking.

7. The parallel radiofrequency blanking switch system of claim 6, wherein the plurality of capacitors is a quantity of two.

8. The parallel radiofrequency blanking switch system of claim 6, wherein the transmission line is electrically connected to support phased array antenna systems.

9. The parallel radiofrequency blanking switch system of claim 6, wherein the control signal is a differential signal.

10. The parallel radiofrequency blanking switch system of claim 6, wherein the control signal is a digital signal.

11. A method for blanking a signal with a parallel radiofrequency blanking switch system, the steps comprising:
providing a parallel radiofrequency blanking switch system, comprising:
a transmission line having at least two ports, and
a plurality parallel radiofrequency blanking switch apparatuses configured to attenuate a plurality of frequencies bands, each further comprising:
a plurality of capacitors electrically connected in parallel to the at least two ports, and configured to not affect the natural electro-magnetic response of the transmission line,
an inductor electrically connected in series with at least one of the plurality of capacitors,
a diode electrically connected to the plurality of capacitors, and
a single direct current power source configured to supply a control signal, wherein the single direct current power source may activate the diode for selective attenuation or blanking;
transmitting a transmission signal through the transmission line;
activating each diode of the plurality of radiofrequency blanking switch apparatuses; and
selectively filtering the transmission signal, and wherein each diode of the plurality of parallel radiofrequency blanking switch apparatuses is tuned to selectively targets a specific frequency band for attenuation or blanking.

12. The method for blanking a signal with a parallel radiofrequency blanking switch system of claim 11, wherein the plurality of capacitors is a quantity of two.

13. The method for blanking a signal with a parallel radiofrequency blanking switch system of claim 11, wherein the transmission line is electrically connected to support phased array antenna systems.

14. The method for blanking a signal with a parallel radiofrequency blanking switch system of claim 11, wherein the control signal is a differential signal.

15. The method for blanking a signal with a parallel radiofrequency blanking switch system of claim 11, wherein the control signal is a digital signal.
